(19) United States
(12) Patent Application Publication
(10) Pub. No.: US 2005/0157690 A1
(43) Pub. Date: Jul. 21, 2005

(54) Wireless network cell controller

(76) Inventors: James Frank, Hollister, CA (US); John Klein, El Dorado Hills, CA (US); Robert Beach, Los Altos, CA (US)

Correspondence Address: BAKER & BOTTS, 30 ROCKEFELLER PLAZA, NEW YORK, NY, 10112, US

(21) Appl. No.: 10/856,157

(22) Filed: May 28, 2004

Related U.S. Application Data
(60) Provisional application No. 60/473,755, filed on May 28, 2003.

(51) Int. Cl. H04J 3/14; H04J 1/16; H04L 1/00; H04L 12/26; H04Q 7/24; H04L 12/28; H04L 12/56

(52) U.S. Cl. 370/338; 370/401

(57) ABSTRACT

A local area network is provided with a cell controller that operates with RF Ports and provides the higher level MAC functions of an access point. In addition the cell controller replaces the router usually used in the local area network to provide layer 3 routing and filtering functions.

### CROSS-REFERENCE TO RELATED APPLICATION

This application claims the benefit of U.S. provisional patent application Ser. No. 60/473,755, filed on May 28, 2004.

### BACKGROUND OF INVENTION

The present invention related to improved cell controllers for wireless networks, and particularly for wireless networks that use the IEEE Standard 802.11 Protocol for wireless communications between a computer or a wired network and mobile units.

In co-assigned and co-pending U.S. patent application Ser. No. 09/528,697, filed Mar. 17, 2000, which is hereby incorporated by reference in its entirety herein, there is described an improved arrangement for carrying out wireless data communications wherein access points are replaced with simplified RF Ports, and wherein certain higher level medium access control (MAC) functions of the access points, such as association and roaming functions are carried out in a cell controller which preferably is a board level personal computer.

It is an object of the present invention to provide an improved cell controller that performs additional functions of a local area network.

### SUMMARY OF THE INVENTION

In accordance with the invention there is provided an improvement in a data communications system wherein RF Ports are provided for communicating (e.g. relaying signals and messages) with mobile units, wherein at least one cell controller is provided for relaying data communications packets between a wired network and the RF Ports, and wherein the cell controller is arranged to perform association and roaming functions for the RF Ports including, for example, sending and receiving association signals between said RF port and said cell controller. In accordance with the improvement the cell controller is further arranged to perform network control functions (e.g., Layer 3 networking functions of the common seven-layer open system interconnection (OSI) reference model). The Layer 3 functions may include filtering addressing, routing, packet formation, Internet protocol (IP) and Quality of Service (QoS) functions.

In one arrangement the cell controller performs IP routing functions for the wired network. In addition, or alternatively, the cell controller is arranged to perform QoS functions for data packets.

For a better understanding of the present invention, together with other and further objects thereof, reference is made to the following description, taken in conjunction with the accompanying drawings, and its scope will be pointed out in the appended claims.

### BRIEF DESCRIPTION OF THE DRAWINGS

FIG. 1 is a block diagram showing a local area network including arrangements for wireless data communications with mobile units according to the prior art.

FIG. 2 is a block diagram of a local area network including arrangements for wireless data communications in accordance with the principles of the present invention.

### DESCRIPTION OF THE INVENTION

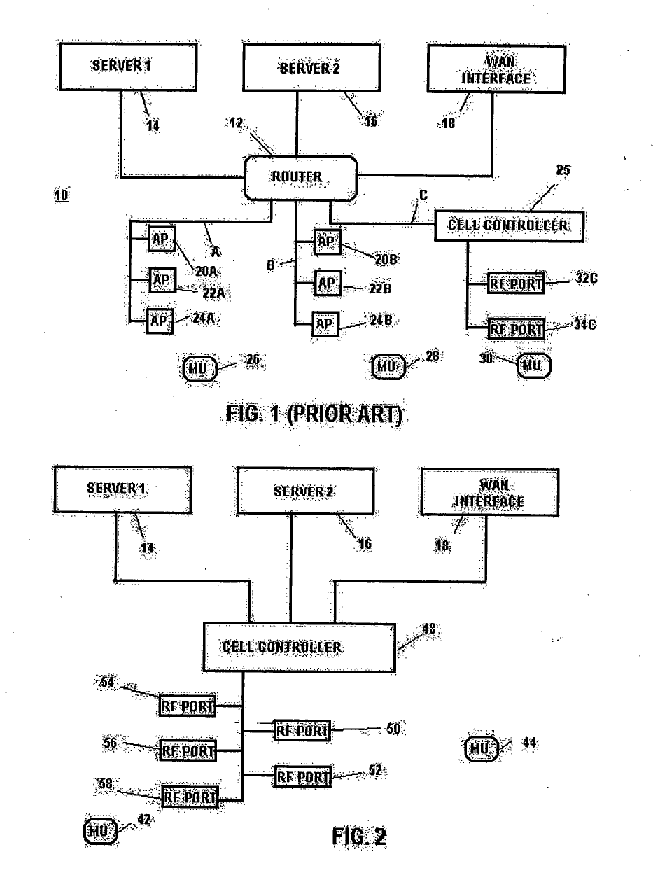

Referring to FIG. 1 there is shown an example of a local area network 10, which includes arrangements for wireless data communications with mobile units according to the prior art. Network 10 includes a router 12, which directs messages within the wired network according to the Internet address and other characteristics of the message. The functions performed by router 12 in addition to switching messages are referred to as layer 3 functions. Among the additional the functions performed by router 12 are network management, which may include prioritization of message traffic. Typically packet messages include an IP address field identifying the destination of the message. The router uses the data in this field to send the packet to the corresponding destination, which may be an access point for further relay over the wireless media, a server such as servers 14 or 16, or a wide area network interface 18. Among the functions performed by router 12 are filtering functions that involve message priority, called Quality of Service (QoS) functions, such as giving priority to message packets to or from destinations associated with emergency functions, such as security. In addition, voice over IP (VoIP) messages may be given priority to provide continuous voice service at the destination. Further the router 12 may have functions involving messages that require encrypting and their transmission over encrypted links. Further, the router 12 may function to direct packets to a portal associated with a virtual network sharing the local area network. The system 10 illustrated for example in FIG. 1 includes a first network branch A having conventional access points 20A, 22A and 24A. A second branch B includes access points 20B, 22B, and 24B. Also illustrated is an arrangement described in the referenced co-pending application that includes a cell controller 25 connected to a third branch C and having RF Ports 32C and 34C. The access points and RF ports communicate with associated mobile units 26, 28 and 30. In this arrangement the combination of the cell controller and RF Ports provide the functions alternately provided by the access points.

Referring to FIG. 2 there is shown an exemplary embodiment of the improvement according to the invention wherein the cell controller 48 is arranged to carry out functions usually provided by a router 12, a switching hub or a bridging switch, in connection with local area network layer 3 filtering and switching, in addition to providing higher level MAC functions for the RF Ports connected thereto. The arrangement of FIG. 2 includes the two servers 14, 16 and WAN interface 18 of the system 10 of FIG. 1, which are directly connected to ports of cell controller 48. Cell controller 48 is also connected directly by an ethernet cable to RF Ports 50, 52, 54, 56, 58, as described in the referenced co-pending application, which communicate with mobile units 42, 44. Accordingly cell controller 48 is configured to provide IP routing, priority and QoS, switching and packet functions usually provided by router 12 in the configuration of FIG. 1, and additionally provides the higher level MAC functions usually performed by access points or the cell controller 25 of the system of FIG. 1. Additionally the cell controller 48 can use the identification of mobile units (e.g., Extended Service Set Identifiers (ESSID)) to route packets and assign priority to packets. In addition, cell controller 48 can analyze network traffic and perform management of network traffic to and from RF Ports. For example, if a particular RF Port has association with an excess or disproportunate number of mobile units (e.g., at a gathering of a large number of users for a meeting), the cell controller 48, which controls the association and roaming functions for the RF Ports, can operate to reassign mobile units to other, less-burdened RF Ports. Since the cell controller has direct control over the operation of the RF Ports, it is in a better position to perform such asset and traffic management functions than router 12 of the system of FIG. 1.

The arrangement of the system of FIG. 2 eliminates the additional hardware associated with the router 12 of system 10 of FIG. 1 and enables more efficient control of network traffic. The system administrator can specify the amount of system bandwidth allocated to various users by their ESSID, and use the cell controller 48 of FIG. 2 to manage the allocation and give preferential or non-preferential treatment to packets based on ESSID identification in each packet.

Those skilled in the art will recognize that the system of FIG. 2 can be expanded to include one or more additional cell controllers and associated RF Ports. In this case, duties and rules concerning network management must be established in all cell controllers and coordinated between them to provide effective network management.

While there have been described what are believed to be the preferred embodiments of the invention, those skilled in the art will recognize that other and further changes and modifications may be made thereto without departing from the spirit of the invention and it is intended to claim all such changes and modifications as fall within the true scope of the invention.

1. In a wireless data communications system, wherein RF Ports are provided for communicating with mobile units, wherein at least one cell controller is provided for relaying data communications packets between a wired network and said RF Ports, and wherein said cell controller is arranged to perform association and roaming functions for said RF Ports, the improvement wherein said cell controller is further arranged to perform layer 3 network control functions.

2. The improvement specified in claim 1 wherein said layer 3 network control functions comprise filtering and switching functions.

3. The improvement specified in claim 1 wherein said cell controller is arranged to perform routing functions.

4. The improvement specified in claim 1 wherein said cell controller is arranged to perform Quality of Service functions.

5. The improvement specified in claim 1 wherein said cell controller is arranged to perform packet formation functions.

6. The improvement specified in claim 1 wherein said cell controller is arranged to perform addressing functions.

7. In a wireless data communications system, wherein RF Ports are provided for communicating with mobile units, wherein at least one cell controller is provided for relaying data communications packets between a wired network and said RF Ports, and wherein said cell controller is arranged to perform association and roaming functions for said RF Ports, the improvement wherein said cell controller is further arranged to perform a function of a router.

8. The improvement specified in claim 7 wherein said cell controller is arranged to perform asset and traffic management functions of a router.

9. The improvement specified in claim 7 wherein said cell controller is arranged to control the assignment of mobile units to the RF ports.

10. The improvement specified in claim 7 wherein said cell controller is arranged to manage bandwidth allocations based on mobile unit identifications.

11. A method for operating a wireless local area network having at least one RF port, a plurality of mobile units and a cell controller coupled to said RF port, comprising:
operating said RF port to relay signals received from mobile units to said cell controller and to relay signals received from said cell controller to said mobile units;
operating said cell controller to control association of said mobile units with said RF port, including sending and receiving association signals between said RF port and said cell controller;
operating said cell controller to send messages to and from said mobile unit via said RF ports; and
operating said cell controller to perform a network control function.

12. The method of claim 11 wherein said network control function is a layer 3 network control function.

13. The method of claim 12 wherein said layer 3 network control function is a routing function.

14. The method of claim 12 wherein said layer 3 network control function is a Quality of Service function.

15. The method of claim 12 wherein said layer 3 network control function is a packet formation function.

16. The method of claim 12 wherein layer 3 network control function is a filtering function.

17. The method of claim 12 wherein layer 3 network control function is an addressing function.

18. A method for operating a wireless local area network that is provided with RF Ports for communicating with mobile units and at least one cell controller for relaying data communications packets between a wired network and said RF Ports, wherein said cell controller is arranged to perform association and roaming functions for said RF Ports, the method comprising using said cell controller to perform the network functions of a router.

19. A method for operating a wireless local area network that is provided with RF Ports for communicating with mobile units and at least one cell controller for relaying data communications packets between a wired network and said RF Ports, wherein said cell controller is arranged to perform association and roaming functions for said RF Ports, the method comprising using said cell controller to control the assignment of mobile units to the RF ports.

20. A method for operating a wireless local area network that is provided with RF Ports for communicating with mobile units and at least one cell controller for relaying data communications packets between a wired network and said RF Ports, wherein said cell controller is arranged to perform association and roaming functions for said RF Ports, the method comprising using said cell controller manage bandwidth allocations based on mobile unit identifications.
